(19) United States
(12) Patent Application Publication
(10) Pub. No.: US 2025/0075033 A1
(43) Pub. Date: Mar. 6, 2025

(54) LOW-MOLECULAR ASYMMETRIC THERMOSETTING POLYPHENYLENE OXIDE RESIN POLYMER, AND PREPARATION METHOD, PURIFICATION METHOD AND USE THEREOF

(71) Applicant: SHANDONG XINGSHUN NEW MATERIAL CO LTD., Heze, Shandong (CN)

(72) Inventor: Xiaoxing GU, Heze (CN)

(21) Appl. No.: 18/553,748

(22) PCT Filed: Feb. 7, 2023
(86) PCT No.: PCT/CN2023/074697

§ 371 Date: Oct. 3, 2023

(51) Int. Cl. C08G 65/48

(52) U.S. Cl. CPC C08G 65/485

(57) ABSTRACT

Provided are a low-molecular weight asymmetric thermosetting polyphenylene oxide (PPO) resin polymer, and a preparation method, a purification method and use thereof, relating to the technical field of resin materials. The low-molecular weight asymmetric thermosetting PPO resin polymer according to the present disclosure has an excellent dielectric property, a desirable film-forming property, a high cost performance, and an excellent comprehensive performance. A bifunctional PPO oligomer is completely reacted in two steps, and the polymer turns fully to thermosetting from thermoplastic. A product with a desirable film-forming property is prepared with reduced cost.

### TECHNICAL FIELD

The present disclosure relates to the technical field of resin materials, in particular to a low-molecular weight asymmetric thermosetting polyphenylene oxide resin polymer, and a preparation method, a purification method and use thereof.

### BACKGROUND

In recent years, with the rapid development of the information industry, signal transmission in high frequency and information processing with high speed expose higher requirements on the dielectric properties and heat resistance of electronic circuit substrates. Polyphenylene oxide (PPO) resin has excellent physical and mechanical properties, heat resistance, and electrical insulation, and shows low hygroscopicity, high strength, and desirable dimensional stability. Moreover, the PPO resin has the best creep resistance at high temperatures among all engineering thermoplastics. Therefore, this resin is currently widely used in electronic circuit substrates.

CN106609032A discloses a thermosetting PPO resin polymer. The polymer is prepared from a thermosetting PPO resin modified with vinyl benzyl ether with five or more functional groups and a vinyl resin cross-linking agent. The prepared resin polymer has excellent dielectric characteristics and heat resistance. However, in order to obtain lower dielectric constant and dielectric loss, this method requires an increased proportion of a vinylbenzyl halide used. Although the prepared substrate has lower dielectric constant and dielectric loss, the vinylbenzyl halide cannot completely react with the PPO resin, resulting in slightly poor film-forming properties and high cost, which cannot meet the needs of customers.

### SUMMARY

An object of the present disclosure is to provide a low-molecular weight asymmetric thermosetting PPO resin polymer, and a preparation method, a purification method and use thereof. In the present disclosure, the low-molecular weight asymmetric thermosetting PPO resin polymer has an excellent dielectric property, a desirable film-forming property, a high cost performance, and an excellent comprehensive performance.

To solve the above technical problems, the present disclosure adopts the following technical solutions.

The present disclosure provides a low-molecular weight asymmetric thermosetting PPO resin polymer, having a structural formula as shown in formula 1:

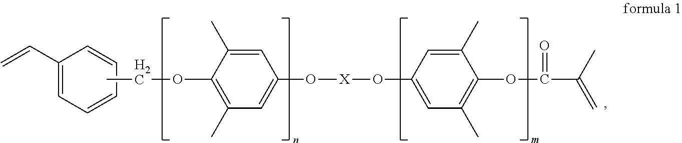

wherein

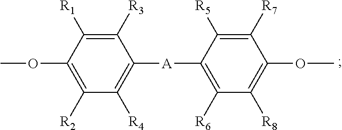

in formula 1, —O—X—O— is

R₁, R₂, R₇, and R₈ are each independently selected from the group consisting of a halogen atom, an alkyl having 1 to 6 carbon atoms, and an aryl; R₃, R₄, R₅, and R₆ are each independently selected from the group consisting of hydrogen atom, a halogen atom, an alkyl having 1 to 6 carbon atoms, and an aryl; A is a single bond or selected from the group consisting of a linear hydrocarbylene group having 1 to 6 carbon atoms, a branched hydrocarbylene group, and a cyclic hydrocarbylene group; and

n and m are each independently an integer of 1 to 30.

In some embodiments, n is in a range of 1 to 20; and m is in a range of 1 to 20.

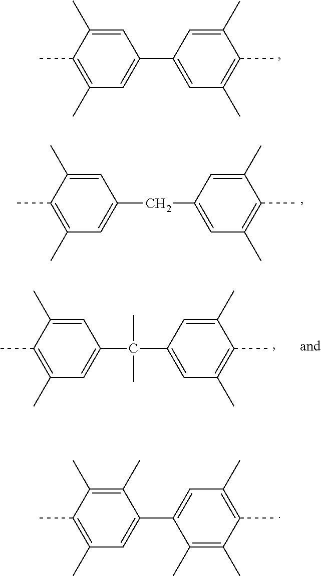

In some embodiments, X is selected from the group consisting of

The present disclosure further provides a method for preparing the low-molecular weight asymmetric thermosetting PPO resin polymer as described in above technical solutions, including the following steps:

mixing a bifunctional PPO oligomer, a polar aprotic solvent, an alkali metal alkoxide, and a vinylbenzyl halide, and subjecting a resulting mixture to an etherification reaction to obtain an etherification reaction system;

mixing the etherification reaction system with an acid-binding agent and a methacryloyl halide, and subjecting a resulting mixture to an esterification reaction to obtain an esterification reaction system; and

adjusting a pH value of the esterification reaction system to 6.0-8.0, and adding the esterification reaction system after adjusting to water or a water-alcohol mixed solution to make precipitation occur, to obtain the low-molecular weight asymmetric thermosetting PPO resin polymer;

wherein the bifunctional PPO oligomer has a structural formula as shown in formula 2:

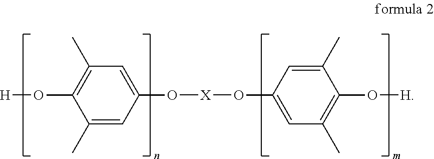

In some embodiments, the polar aprotic solvent includes one or more selected from the group consisting of toluene, N,N-dimethylformamide (DMF), N,N-dimethylacetamide (DMA), and 1-methyl-2-pyrrolidone.

In some embodiments, the alkali metal alkoxide includes one or more selected from the group consisting of lithium methoxide, sodium methoxide, potassium methoxide, lithium ethoxide, sodium ethoxide, and potassium ethoxide.

In some embodiments, the vinylbenzyl halide includes one or more selected from the group consisting of m-vinylbenzyl chloride, p-vinylbenzyl chloride, m-vinylbenzyl bromide, and p-vinylbenzyl bromide.

In some embodiments, a molar ratio of the alkali metal alkoxide to a phenolic hydroxyl group in the bifunctional PPO oligomer is in a range of (0.9-4.8):1; and a molar ratio of the vinylbenzyl halide to the phenolic hydroxyl group in the bifunctional PPO oligomer is in a range of (0.5-2.0):1.

In some embodiments, the etherification reaction is conducted at a temperature of 0-90° C. for 10 min to 30 h.

In some embodiments, the acid-binding agent includes one or more selected from the group consisting of triethylamine (TEA), pyridine, N,N-diisopropylethylamine, 4-dimethylaminopyridine, triethanolamine, tetrabutylammonium bromide, potassium carbonate, ammonium carbonate, and sodium carbonate.

In some embodiments, the methacryloyl halide is one or two selected from the group consisting of methacryloyl chloride and methacryloyl bromide.

In some embodiments, a molar ratio of the acid-binding agent to the bifunctional PPO oligomer is in a range of (1-2):1; and

a molar ratio of the methacryloyl halide to a phenolic hydroxyl group in the bifunctional PPO oligomer is in a range of (0.5-2):1.

In some embodiments, the esterification reaction is conducted at a temperature of 0-90° C. for 10 min to 30 h.

The present disclosure further provides a method for improving a purity of a low-molecular weight asymmetric thermosetting PPO resin polymer, including the following steps:

mixing a crude product of a low-molecular weight asymmetric thermosetting PPO resin polymer prepared by the method as described in above technical solutions with a polar aprotic solvent, a polymerization inhibitor, and diethylamine to obtain a mixed solution; adding the mixed solution into water to make precipitation occur, to obtain a first solid substance;

mixing the first solid substance with water, and pulverizing to obtain a first dispersion; conducting solid-liquid separation on the first dispersion to obtain a second solid substance;

mixing the second solid substance with water, and conducting beating to obtain a second dispersion;

mixing the second dispersion with acetic acid, subjecting a resulting mixture to a neutralization reaction, and conducting solid-liquid separation to obtain a third solid substance; and

conducting beating on the third solid substance in water and methanol in sequence to obtain the low-molecular weight asymmetric thermosetting PPO resin polymer.

In some embodiments, the polymerization inhibitor is tris(2,3-dibromopropyl)isocyanurate.

In some embodiments, the low-molecular weight asymmetric thermosetting PPO resin polymer has a chlorine content of less than 50 ppm, a vinylbenzyl chloride (VBC) content of less than or equal to 15 ppm, a NaCl content of less than or equal to 25 ppm, and a (C₂H₅)₃N·HCl content of less than or equal to 5 ppm.

The present disclosure further provides use of the low-molecular weight asymmetric thermosetting PPO resin polymer as described in above technical solutions or a low-molecular weight asymmetric thermosetting PPO resin polymer prepared by the preparation method as described in above technical solutions or a low-molecular weight asymmetric thermosetting PPO resin polymer prepared by the method for improving a purity of a low-molecular weight asymmetric thermosetting PPO resin polymer as described in above technical solutions in an electronic circuit substrate.

The present disclosure provides a low-molecular weight asymmetric thermosetting PPO resin polymer. In the present disclosure, in a structure of the polymer, a methacryl group has extremely low activity, and cannot be reacted completely, while a styrene group has high activity, can be complementary to the methacryl group, and reacts quickly. Therefore, the polymer has desirable film-forming properties, high cross-linking effect, and obviously-improved comprehensive performance.

In the present disclosure, the low-molecular weight asymmetric thermosetting PPO resin polymer has no strongly polar group in its molecular structure, and exhibits desirable electrical insulation, and stable electrical properties. The polymer has a dielectric constant and a dielectric loss tangent that are relatively smaller among engineering plastics, and hardly affected by temperature, humidity and the like. Moreover, the polymer has a volume resistivity which is relatively high among the engineering plastics, and thus exhibits excellent dielectric properties.

A molecular chain of the low-molecular weight asymmetric thermosetting PPO resin polymer contains a large number of aromatic ring structures. Vinylbenzyl and methacrylate groups block the phenolic group active sites, enhance the rigidity and intermolecular cohesion of the molecule, such that the molecular chain has a strong sensitivity. Moreover, the polymer contains no polar hydrolyzable group and exhibits a higher glass transition temperature, thus showing high heat resistance.

In the present disclosure, the low-molecular weight asymmetric thermosetting PPO resin polymer has an excellent dielectric property, a desirable film-forming property, a high cost performance, and an excellent comprehensive performance.

The present disclosure further provides a preparation method of the low-molecular weight asymmetric thermosetting PPO resin polymer. In the present disclosure, the bifunctional PPO oligomer is completely reacted in two steps, and the polymer turns fully to thermosetting from thermoplastic. A product with a desirable film-forming property is prepared with reduced cost. The low-molecular weight asymmetric thermosetting PPO resin polymer prepared has excellent dielectric properties and heat resistance, desirable comprehensive properties, and high cost performance.

### BRIEF DESCRIPTION OF THE DRAWINGS

FIG. 1 shows a hydrogen nuclear magnetic resonance (1H-NMR) spectrum of the low-molecular weight asymmetric thermosetting PPO resin polymer prepared in Example 1.

FIG. 2 shows a gel permeation chromatography (GPC) spectrum of the low-molecular weight asymmetric thermosetting PPO resin polymer prepared in Example 1.

### DETAILED DESCRIPTION OF THE EMBODIMENTS

The present disclosure is further described below with reference to the accompanying drawings and examples.

The present disclosure provides a low-molecular weight asymmetric thermosetting PPO resin polymer, having a structural formula as shown in formula 1:

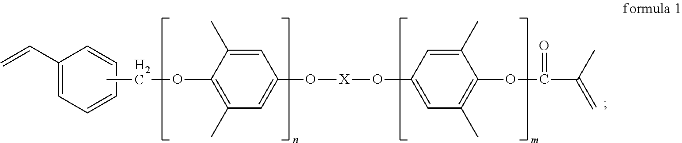

wherein in formula 1, —O—X—O— is

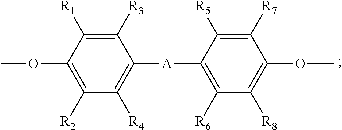

R₁, R₂, R₇, and R₈ are each independently selected from the group consisting of a halogen atom, an alkyl having 1 to 6 carbon atoms, and an aryl; R₃, R₄, R₅, and R₆ are each independently selected from the group consisting of hydrogen atom, a halogen atom, an alkyl having 1 to 6 carbon atoms, and an aryl; A is a single bond or selected from the group consisting of a linear hydrocarbylene group having 1 to 6 carbon atoms, a branched hydrocarbylene group, and a cyclic hydrocarbylene group; and

n and m are each independently an integer of 1 to 30.

In some embodiments of the present disclosure, the n is in a range of 1 to 20. In some embodiments, the m is in a range of 1 to 20.

In some embodiments of the present disclosure, the alkyl having 1 to 6 carbon atoms is a substituted alkyl. In some embodiments, the aryl is a substituted aryl. In some embodiments, A is selected from the group consisting of a linear hydrocarbylene group having 1 to 3 carbon atoms, a branched hydrocarbylene group, and a cyclic hydrocarbylene group.

In some embodiments of the present disclosure, R₁, R₂, R₇, and R⁸ are each independently selected from the group consisting of chlorine, methyl, and benzyl. In some embodiments, R₃, R₄, R₅, and R₆ are each independently selected from the group consisting of hydrogen atom, chlorine, methyl, and benzyl. In some embodiments, the linear hydrocarbylene group is methylene group. In some embodiments, the branched hydrocarbylene group is isopropylidene group. In some embodiments, the cyclic hydrocarbylene group is cyclohexylisopropylidene group.

In a specific embodiment of the present disclosure, R₁ is methyl; R₂ is methyl; R₃ is hydrogen atom or a halogen atom; R₄ is hydrogen atom or a halogen atom; R₅ is hydrogen atom or a halogen atom; R₆ is hydrogen atom or a halogen atom; R₇ is methyl; R₈ is methyl; and A is isopropylidene.

In a specific embodiment of the present disclosure, X is selected from the group consisting of

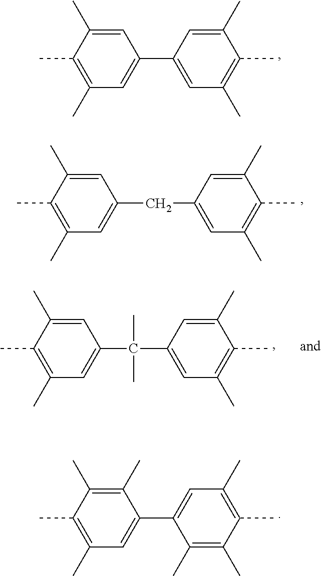

The present disclosure further provides a method for preparing the low-molecular weight asymmetric thermosetting PPO resin polymer as described in the above technical solutions, including the following steps:

mixing a bifunctional PPO oligomer, a polar aprotic solvent, an alkali metal alkoxide, and a vinylbenzyl halide, and subjecting a resulting mixture to an etherification reaction, to obtain an etherification reaction system;

mixing the etherification reaction system with an acid-binding agent and a methacryloyl halide, and subjecting a resulting mixture to an esterification reaction to obtain an esterification reaction system; and

adjusting a pH value of the esterification reaction system to 6.0-7.0, and adding the esterification reaction system after adjusting to water or a water-alcohol mixed solution to make precipitation occur, to obtain the low-molecular weight asymmetric thermosetting PPO resin polymer.

In the present disclosure, a bifunctional PPO oligomer, a polar aprotic solvent, an alkali metal alkoxide, and a vinylbenzyl halide are mixed, and a resulting mixture is subjected to an etherification reaction, to obtain an etherification reaction system, wherein the bifunctional PPO oligomer has a structural formula as shown in formula 2:

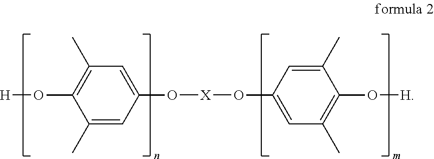

In some embodiments of the present disclosure, the bifunctional PPO oligomer is prepared by a process including: mixing 2,6-dimethylphenol, HO—X—OH, methanol, toluene, and a copper-amine catalyst, and subjecting a resulting mixture to oxidative polymerization in oxygen to obtain the bifunctional PPO oligomer. In some embodiments, the copper-amine catalyst includes cuprous chloride, di-n-butylamine, and N,N,N′,N′-tetramethyl-1,3-propanediamine.

In some embodiments of the present disclosure, mixing the 2,6-dimethylphenol, HO—X—OH, methanol, toluene, and the copper-amine catalyst includes: mixing part of the methanol, part of the toluene, the cuprous chloride, part of the di-n-butylamine and part of the N,N,N′,N′-tetramethyl-1,3-propanediamine to obtain a first mixed solution; mixing the remaining methanol, the remaining toluene, the 2,6-dimethylphenol, the HO—X—OH, the remaining di-n-butylamine, and the remaining N,N,N′,N′-tetramethyl-1,3-propanediamine to obtain a second mixed solution; and adding the second mixed solution dropwise into the first mixed solution. In some embodiments, a mass ratio of the part of the methanol, the part of the toluene, the cuprous chloride, the part of the di-n-butylamine, and the part of the N,N,N′,N′-tetramethyl-1,3-propanediamine is in a range of (500-5000):(500-5000):(10-150):(1-3):(10-200), preferably 1000:1000:30:1:25. In some embodiments, a dosage ratio of the remaining methanol, the remaining toluene, the 2,6-dimethylphenol, the HO—X—OH, the remaining di-n-butylamine, and the remaining N,N,N′,N′-tetramethyl-1,3-propanediamine is in a range of (500-5000) g:(500-5000) g:(1-15) mol:(1-3) mol:(1-5) g:(5-120) g, and preferably 2000 g:2000 g:5.6 mol:1.2 mol:1 g:30 g. In some embodiments, a mass ratio of the second mixed solution to the first mixed solution is in a range of (1-6):1, and preferably 2:1. In some embodiments, the mixing is conducted at a temperature of 10° C. to 50° C., and preferably 30° C. In some embodiments, the second mixed solution is added dropwise into the first mixed solution within 3 h.

In some embodiments of the present disclosure, an inflow rate of the oxygen is in a range of 1 L/min to 5 L/min, and preferably 1.5 L/min. In some embodiments, after the second mixed solution is added dropwise into the first mixed solution, the oxygen is continuously introduced for 2 h.

In some embodiments of the present disclosure, the oxidative polymerization is conducted at a temperature of 20° C. to 80° C., and preferably 40° C. In some embodiments, the oxidative polymerization is conducted for 1 h to 8 h, and preferably 3 h.

In some embodiments of the present disclosure, after the oxidative polymerization, the preparation method further includes: adding glacial acetic acid to terminate the oxidative polymerization, adding water to wash an obtained reaction solution, and separating out an aqueous phase and an organic layer; washing the organic layer with water, and concentrating to obtain a solution of the bifunctional PPO oligomer in toluene; pouring the solution of the bifunctional PPO oligomer in toluene into methanol to precipitate particles, and conducting solid-liquid separation to obtain the bifunctional PPO oligomer having a structural formula as shown in formula 2. In some embodiments, a mass ratio of the glacial acetic acid, the 2,6-dimethylphenol, the HO—X—OH, the methanol, the toluene, and the copper-amine catalyst is in a range of 1:(2-24):(3-56):(15-200):(15-200):(0.5-8), and preferably 1:12:28:100:100:2.

In some embodiments of the present disclosure, the bifunctional PPO oligomer has a number-average molecular weight of 1,200 g/mole and a weight-average molecular weight of 2,200 g/mole.

In a specific embodiment of the present disclosure, a chemical reaction equation for preparing the bifunctional PPO oligomer is as follows:

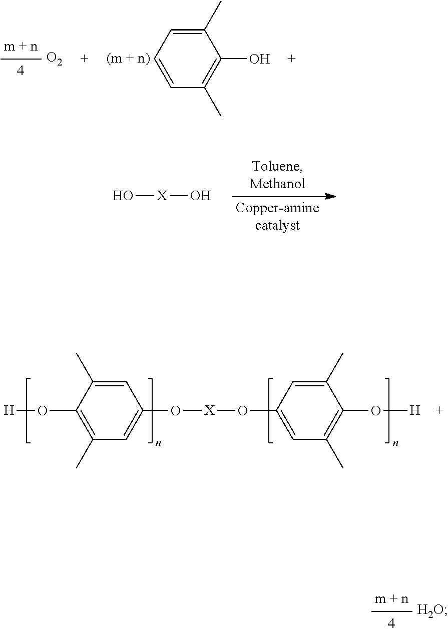

where X is consistent with the X in formula 1.

In some embodiments of the present disclosure, the polar aprotic solvent includes one or more selected from the group consisting of toluene, DMF, DMA, and 1-methyl-2-pyrrolidone. In a specific example, when the polar aprotic solvent is the toluene and DMF, a mass ratio of the toluene to the DMF is 1:1. In some embodiments, a mass ratio of the polar aprotic solvent to the bifunctional PPO oligomer is in a range of (1-20):1, and preferably 2:1.

In some embodiments of the present disclosure, the alkali metal alkoxide includes one or more selected from the group consisting of lithium methoxide, sodium methoxide, potassium methoxide, lithium ethoxide, sodium ethoxide, and potassium ethoxide. In some embodiments, a molar ratio of the alkali metal alkoxide to a phenolic hydroxyl group in the bifunctional PPO oligomer is in a range of (0.9-4.8):1, and preferably (1.0-2.4):1. In the present disclosure, the alkali metal alkoxide and the bifunctional PPO oligomer react to form an ether. When the alkali metal alkoxide is used in at least an equimolar amount to that amount, the bifunctional PPO oligomer can be produced with a very low residual unreacted content; the remaining unreacted portion becomes an ionic impurity.

In some embodiments of the present disclosure, the vinylbenzyl halide includes one or more selected from the group consisting of m-vinylbenzyl chloride, p-vinylbenzyl chloride, m-vinylbenzyl bromide, and p-vinylbenzyl bromide. In some embodiments, a molar ratio of the vinylbenzyl halide to the phenolic hydroxyl group in the bifunctional PPO oligomer is in a range of (0.5-2.0):1, and preferably (1.0-2.0):1. In the present disclosure, when the amount of the vinylbenzyl halide is small, the residual amount of unreacted phenolic hydroxyl groups increases, resulting in a decrease in the dielectric characteristics of a cured product. When the amount of the vinylbenzyl halide is large, only the amount of unreacted bifunctional PPO oligomer is increased while the reaction is not changed, which lowers the dielectric characteristics of the cured product and causes economical disadvantages.

In some embodiments of the present disclosure, mixing the bifunctional PPO oligomer, the polar aprotic solvent, the alkali metal alkoxide, and the vinylbenzyl halide includes: dissolving the bifunctional PPO oligomer in the polar aprotic solvent; adding the alkali metal alkoxide thereto, and heating, stirring, and removing alcohol; and adding the vinylbenzyl halide thereto. In some embodiments, the bifunctional PPO oligomer is dissolved in the polar aprotic solvent at a temperature of 40° C. to 80° C. In some embodiments, the heating and stirring are conducted at a temperature of 50° C. to 60° C. In some embodiments, the heating and stirring are conducted for 1 h.

In some embodiments of the present disclosure, the etherification reaction is conducted at a temperature of 0° C. to 90° C., and preferably 30° C. to 60° C. In some embodiments, the etherification reaction is conducted for 10 min to 30 h, and preferably 3 h to 6 h. In some embodiments, the etherification reaction includes a low-temperature reaction and a high-temperature reaction that are conducted sequentially. In some embodiments, the low-temperature reaction is conducted at a temperature of 0° C. to 10° C. In some embodiments, the low-temperature reaction is conducted for 1 h to 6 h, and preferably 3 h. In some embodiments, the high-temperature reaction is conducted at a temperature of 50° C. to 60° C. In some embodiments, the high-temperature reaction is conducted for 1 h to 6 h, and preferably 3 h.

In some embodiments of the present disclosure, after the etherification reaction, an obtained system is cooled to a temperature of 30° C. to 40° C. to obtain the etherification reaction system. In the present disclosure, the etherification reaction mainly produces a product with a hydroxyl sodium salt at one end and a styryl terminal at the other end.

In the present disclosure, after obtaining the etherification reaction system, the etherification reaction system is mixed with an acid-binding agent and a methacryloyl halide, and a resulting mixture is subjected to an esterification reaction to obtain an esterification reaction system. In some embodiments, the acid-binding agent includes one or more selected from the group consisting of TEA, pyridine, N,N-diisopropylethylamine, 4-dimethylaminopyridine, triethanolamine, tetrabutylammonium bromide, potassium carbonate, ammonium carbonate, and sodium carbonate. In some embodiments, a molar ratio of the acid-binding agent to the bifunctional PPO oligomer is in a range of (1-2):1:1, and preferably 1.3:1.

In some embodiments of the present disclosure, the methacryloyl halide is one or two selected from the group consisting of methacryloyl chloride and methacryloyl bromide. In some embodiments, a molar ratio of the methacryloyl halide to the phenolic hydroxyl group in the bifunctional PPO oligomer is in a range of (0.5-2):1, and preferably (1.0-2.0):1. When the dosage of the methacryloyl halide is small, the residual amount of unreacted phenolic hydroxyl groups increases, resulting in a decrease in the dielectric characteristics of a cured product. When the dosage of the methacryloyl halide is large, only the amount of unreacted bifunctional PPO oligomer is increased while the reaction is not changed, which lowers the dielectric characteristics of the cured product and causes economical disadvantages.

In some embodiments of the present disclosure, mixing the etherification reaction system with the acid-binding agent and the methacryloyl halide includes: sequentially adding the acid-binding agent and the methacryloyl halide into the etherification reaction system.

In some embodiments of the present disclosure, the esterification reaction is conducted at a temperature of 0° C. to 90° C., and preferably 30° C. to 60° C. In some embodiments, the esterification reaction is conducted for 10 min to 30 h, and preferably 3 h to 6 h. In some embodiments, the esterification reaction includes a low-temperature reaction and a high-temperature reaction that are conducted sequentially. In some embodiments, the low-temperature reaction is conducted at a temperature of 0° C. to 10° C. In some embodiments. the low-temperature reaction is conducted for 1 h to 6 h, and preferably 3 h. In some embodiments, the high-temperature reaction is conducted at a temperature of 50° C. to 60° C. In some embodiments, the high-temperature reaction is conducted for 1 h to 6 h, and preferably 3 h.

In the present disclosure, after obtaining the esterification reaction system, a pH value of the esterification reaction system is adjusted to 6.0 to 8.0, and the esterification reaction system after adjusting is added to water or a water-alcohol mixed solution to make precipitation occur. to obtain the low-molecular weight asymmetric thermosetting PPO resin polymer. In some embodiments, the pH value of the esterification reaction system is adjusted to 6.0 to 8.0, and preferably 6.0 to 7.0 with an acidic substance. In some embodiments, the acidic substance includes one or more selected from the group consisting of phosphoric acid, sulfuric acid, hydrochloric acid, benzenesulfonic acid, and benzoic acid, and preferably the hydrochloric acid.

In some embodiments of the present disclosure, an alcohol in the water-alcohol mixed solution includes one or more selected from the group consisting of methanol, ethanol, n-propanol, and isopropanol, and preferably the methanol or the ethanol. In some embodiments, the water-alcohol mixed solution has an alcohol content of 40 wt % to 95 wt %, and preferably 50 wt % to 90 wt %. In the present disclosure, when the alcohol content is less than 40 wt %, the obtained PPO resin polymer becomes emulsified and thus it is difficult to handle. When the alcohol content is greater than 95 wt %, by-product salts contained in the reaction solution and generated during the reaction cannot be sufficiently dissolved and removed due to a small water content.

In the present disclosure, the esterification reaction system is directly added to the water or water-alcohol mixed solution without a step of washing an organic layer with pure water or the like, thereby precipitating solids. In general, when an organic solution in which an oligomer is dissolved is washed with water, it is difficult to separate out an aqueous layer and an organic layer due to emulsification after modification, such that liquid-separation washing takes an extremely long time. Furthermore, even when the liquid-separation washing is conducted with water, it is highly difficult to completely remove by-product salts generated during the reaction. The preparation method of the present disclosure can omit such complex liquid-separation washing and can adopt coagulation by using the water or water-alcohol mixed solution, thereby dissolving and removing the by-product salts produced during the reaction.

In some embodiments of the present disclosure, after the precipitation, an obtained precipitate is subjected to water washing, alcohol washing, and drying sequentially to obtain the low-molecular weight asymmetric thermosetting PPO resin polymer. In some embodiments, the water washing is conducted with deionized water. In some embodiments, the alcohol washing is conducted with methanol. In some embodiments, the alcohol washing is conducted by immersing. In some embodiments, the drying is conducted at 80° C. By the water washing and the alcohol washing, by-product salts generated during the reaction can be dissolved and removed.

In some embodiments of the present disclosure, after the water washing, alcohol washing, and drying, a crude product of the low-molecular weight asymmetric thermosetting PPO resin polymer is obtained; the crude product of the low-molecular weight asymmetric thermosetting PPO resin polymer is subjected to purification. Through the purification, a halogen content and a salt content of the product are further reduced, such that a dielectric loss factor Df is further reduced.

The purification will be described in details below.

The present disclosure further provides a method for improving a purity of a low-molecular weight asymmetric thermosetting PPO resin polymer, including the following steps:

mixing a crude product of a low-molecular weight asymmetric thermosetting PPO resin polymer prepared by the preparation method with a polar aprotic solvent, a polymerization inhibitor, and diethylamine to obtain a mixed solution; adding the mixed solution into water to make precipitation occur, to obtain a first solid substance; mixing the first solid substance with water, and pulverizing to obtain a first dispersion; conducting solid-liquid separation on the first dispersion to obtain a second solid substance; mixing the second solid substance with water, and beating to obtain a second dispersion; mixing the second dispersion with acetic acid, and subjecting a resulting mixture to a neutralization reaction and solid-liquid separation in sequence to obtain a third solid substance; and conducting beating on the third solid substance in water and methanol in sequence to obtain the low-molecular weight asymmetric thermosetting PPO resin polymer. In some embodiments of the disclosure, the water is distilled water.

In some embodiments of the present disclosure, a crude product of a low-molecular weight asymmetric thermosetting PPO resin polymer obtained by precipitation is mixed with a polar aprotic solvent, a polymerization inhibitor, and diethylamine to obtain a mixed solution. In some embodiments, the polar aprotic solvent includes DMF, DMA, dimethyl sulfoxide (DMSO), and 1-methyl-2-pyrrolidone. In some embodiments, a mass ratio of the crude product of the low-molecular weight asymmetric thermosetting PPO resin polymer and the polar aprotic solvent is in a range of 1:(2-20), and preferably 1:2.5. In some embodiments, the polymerization inhibitor is tris(2,3-dibromopropyl)isocyanurate (TBC). In some embodiments, a mass ratio of the crude product of the low-molecular weight asymmetric thermosetting PPO resin polymer to the polymerization inhibitor is in a range of (1000-10000):0.1, and preferably 1000:0.4. In some embodiments, a mass ratio of the crude product of the low-molecular weight asymmetric thermosetting PPO resin polymer to the diethylamine is in a range of 1000:(10-500), and preferably 1000:65. In the present disclosure, the diethylamine reacts with unreacted p-vinylbenzyl chloride to generate hydrochloride, and the hydrochloride is easily soluble in water to achieve the effect of removing halogen.

In some embodiments of the present disclosure, mixing the crude product of the low-molecular weight asymmetric thermosetting PPO resin polymer with the polar aprotic solvent, the polymerization inhibitor, and the diethylamine includes: mixing the crude product of the low-molecular weight asymmetric thermosetting PPO resin polymer with the polar aprotic solvent, adding the polymerization inhibitor thereto, heating for dissolving, adding the diethylamine thereto, and stirring. In some embodiments, the heating for dissolving refers to heating to a temperature of 0° C. to 80° C., and preferably 35° C. In some embodiments, the stirring is conducted at a rate of 100 r/min to 300 r/min. In some embodiments, the stirring is conducted for 2 h.

In some embodiments of the present disclosure, after obtaining the mixed solution, the mixed solution is added into water to make precipitation occur, to obtain a first solid substance. In some embodiments, a mass ratio of the crude product of the low-molecular weight asymmetric thermosetting PPO resin polymer to water is in range of 1:(5-100), and preferably 1:18. In some embodiments, after the precipitation, suction filtration is conducted to obtain the first solid substance.

In some embodiments of the present disclosure, after obtaining the first substance, the first solid substance is mixed with water, and pulverized to obtain a first dispersion. In some embodiments, a mass ratio of the water to the crude product of the low-molecular weight asymmetric thermosetting PPO resin polymer is in a range of (5-100):1, and preferably 18:1. In some embodiments, the pulverization is conducted in a wall breaker. In some embodiments, the pulverization is conducted for 10 s to 200 s. In some embodiments, stirring is conducted 30 s after the pulverization to obtain the first dispersion. In some embodiments, the stirring is conducted at a rotation rate of 100 r/min to 300 r/min. In some embodiments, the stirring is conducted for 1 h. The salts are removed from a resulting solid by the pulverization.

In some embodiments of the present disclosure, after obtaining the first dispersion, solid-liquid separation is conducted on the first dispersion to obtain a second solid substance. In some embodiments, the solid-liquid separation is conducted by suction filtration.

In some embodiments of the present disclosure, after obtaining the second solid substance, the second solid substance is mixed with water, and beating is conducted to obtain a second dispersion. In some embodiments, a mass ratio of the water to the crude product of the low-molecular weight asymmetric thermosetting PPO resin polymer is in a range of (5-100):1, and preferably 18:1. In some embodiments, the beating is conducted with the following parameters: a temperature of 20° C. to 30° C. and 100 r/min to 300 r/min. In some embodiments, the beating is conducted for 1 h.

In some embodiments of the present disclosure, after obtaining the second dispersion, the second dispersion is mixed with acetic acid, and a resulting mixture is subjected to a neutralization reaction and solid-liquid separation in sequence to obtain a third solid substance. There is no special requirement on a dosage of the acetic acid, as long as a pH value of a system obtained after the neutralization reaction is preferably less than 6, and preferably 5.5 to 6. In some embodiments, the solid-liquid separation is conducted by suction filtration. The residual diethylamine is neutralized with the acetic acid to form a salt.

In the present disclosure, after obtaining the third solid, beating is conducted on the third solid substance in water and methanol in sequence to obtain the low-molecular weight asymmetric thermosetting PPO resin polymer. In some embodiments, a mass ratio of the water to the crude product of the low-molecular weight asymmetric thermosetting PPO resin polymer is in a range of (5-100):1, and preferably 18:1. In some embodiments, a mass ratio of the methanol to the crude product of the low-molecular weight asymmetric thermosetting PPO resin polymer is in a range of (2-20):1, and preferably 4:1. In some embodiments, beating the third solid substance in water is performed with the following parameters: a temperature of 20° C. to 30° C. 100 r/min to 300 r/min, and a time of 1 h. In some embodiments, beating the third solid substance in methanol is performed for 2 times. In some embodiments, beating the third solid substance in methanol for each time is performed with the following parameters: a temperature of 20° C. to 30° C. 100 r/min to 300 r/min. In some embodiments, the beating is performed for 1 h each time. In some embodiments, solid-liquid separation is conducted after the beating in water, and an obtained solid substance is then subjected to the beating in methanol. In some embodiments, the polymerization inhibitor is added during the beating of last time in methanol. In some embodiments, the polymerization inhibitor is the TBC. In some embodiments, a mass ratio of the crude product of the low-molecular weight asymmetric thermosetting PPO resin polymer to the polymerization inhibitor is in a range of (1000-10000):0.1, and preferably 1000:0.14. In some embodiments, after the beating, solid-liquid separation is conducted, and an obtained solid substance is dried to obtain the low-molecular weight asymmetric thermosetting PPO resin polymer. In some embodiments, the solid-liquid separation is conducted by suction filtration. In some embodiments, the drying is conducted at a temperature of 20° C. to 60° C. In some embodiments, the drying is conducted for 8 h to 48 h. In the present disclosure, organic salts are easily soluble in water and alcohol. In the present disclosure, beating in water and methanol is beneficial to removing salts in solids.

In some embodiments of the present disclosure, the low-molecular weight asymmetric thermosetting PPO resin polymer has a chlorine content of less than 50 ppm, a VBC (4-vinylbenzyl chloride, 3-vinylbenzyl chloride, and 2-vinylbenzyl chloride) content of less than or equal to 15 ppm, a NaCl (sodium chloride) content of less than or equal to 25 ppm, and a (C₂H₅)₃N·HCl (triethylamine hydrochloride) content of less than or equal to 5 ppm; and a Df of 0.003.

In the present disclosure, it is possible to efficiently produce a low-molecular weight asymmetric thermosetting PPO resin polymer with a highly small content of ionic impurities and a highly small content of residual alkali metal ions. The preparation method of the present disclosure is more economical by completely reacting the bifunctional PPO oligomer in two steps without extremely complicated washing solution-separation steps. Furthermore, a cured product obtained by thermally curing the low-molecular weight asymmetric thermosetting PPO resin polymer has remarkably excellent dielectric properties and film-forming properties, such that the cured product can be used as a matrix in the field of electric and electronic materials.

The present disclosure also provides use of the low-molecular weight asymmetric thermosetting PPO resin polymer as described in above technical solutions or a low-molecular weight asymmetric thermosetting PPO resin polymer prepared by the preparation method as described in above technical solutions or a low-molecular weight asymmetric thermosetting PPO resin polymer prepared by the method for improving a purity of a low-molecular weight asymmetric thermosetting PPO resin polymer as described in above technical solutions in an electronic circuit substrate.

The low-molecular weight asymmetric thermosetting PPO resin polymer, and the preparation method, the purification method and the use thereof according to the present disclosure are described below in detail in conjunction with examples. However, the following description cannot be understood as a limit to the scope of the present disclosure.

### EXAMPLE 1

(1) To a reaction flask with a volume of 20 L equipped with a stirrer, a thermometer, a dropping funnel, a condenser, and an oxygen inlet tube, 2,000 g of methanol, 2,000 g of toluene, 60 g of cuprous chloride, 2 g of di-n-butylamine, and 50 g of N,N,N′,N′-tetramethyl-1,3-propanediamine were added. They were stirred at 30° C. to obtain a mixture. 686 g of 2,6-dimethylphenol, 288 g of 3,3′,5,5′-tetramethyl-(1,l′-biphenyl)-4,4′-diol, 1 g of di-n-butylamine, and 30 g of N,N,N′,N′-tetramethyl-1,3-propanediamine were dissolved in 2,000 g of the methanol and 2,000 g of the toluene in advance to obtain a mixed solution. At 30° C., the mixed solution was added dropwise into the mixture in the reaction flask within 3 h, while oxygen was introduced for bubbling. After the adding dropwise, oxygen was introduced for bubbling for another 2 h, and 100 g of glacial acetic acid was then added thereto to terminate a reaction, obtaining a reaction solution. 6,000 g of water was added thereto to wash the reaction solution, and an aqueous phase and an organic layer were separated out. The organic layer was washed with water, concentrated by an evaporator to obtain 2,000 g of a solution of a bifunctional phenylene ether oligomer in toluene. It was then slowly poured into 6,000 g of methanol, and particles were precipitated. Stirring was conducted for 0.5 h, followed by suction filtration, and a resulting filter cake was dried to obtain 840 g of a bifunctional polyphenylene oxide (PPO) oligomer with a structural formula as shown in formula 2, the PPO having a number-average molecular weight of 1,200 and a weight-average molecular weight of 2,200.

A chemical reaction equation for preparing the bifunctional PPO oligomers was as follows:

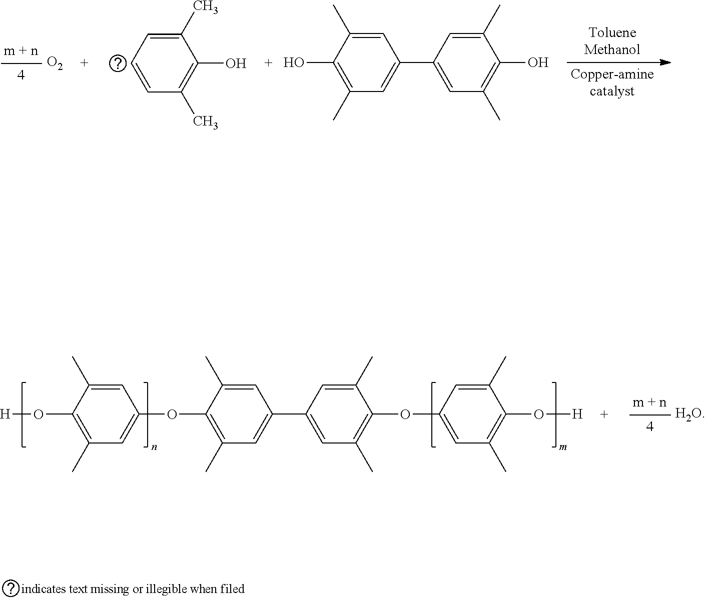

(2) To a reaction flask with a volume of 5 L, equipped with a stirrer, a thermometer, and a condenser, 800 g of the PPO, 800 g of toluene, and 800 g of DMF were added. The PPO was completely dissolved at 40° C. 42 g of sodium methoxide was then added in batches. The resulting mixture was stirred at 50° C. to 60° C. for 1 h, and methanol was removed under reduced pressure (using a mechanical pump to 60° C.). The remaining was cooled, and 120 g of mixed vinylbenzyl chloride (including 76 wt % of o-vinylbenzyl chloride, 17 wt % of p-vinylbenzyl chloride, and 5 wt % of m-vinylbenzyl chloride) was added thereto dropwise at 40° C. After adding dropwise, an obtained reaction solution was held at 40° C. for 3 h and held at 60° C. for 3h. After the heat preservation, the reaction solution was cooled to 30° C., 87 g of TEA was added thereto, and 83 g of methacryloyl chloride was added thereto dropwise at 30° C. After adding dropwise, a reaction solution was held at 30° C. for 3 h and held at 60° C. for 3 h. After the reaction, an obtained reaction solution was added dropwise to a mixed solution of 4,000 g of methanol, 200 g of hydrochloric acid, and 500 g of water (under stirring), solids were precipitated, and stirring was continued for 0.5 h. Suction filtration was conducted, an obtained filter cake was washed several times with 10 L of deionized water, and immersed in methanol for 0.5 h. The suction filtration was conducted, and a resulting product was dried at 80° C. to obtain 865 g of a crude product of a low-molecular weight asymmetric thermosetting PPO resin polymer. The dielectric characteristics of the crude product of the low-molecular weight asymmetric thermosetting PPO resin polymer are shown in Table 1.

A chemical reaction equation was as follows:

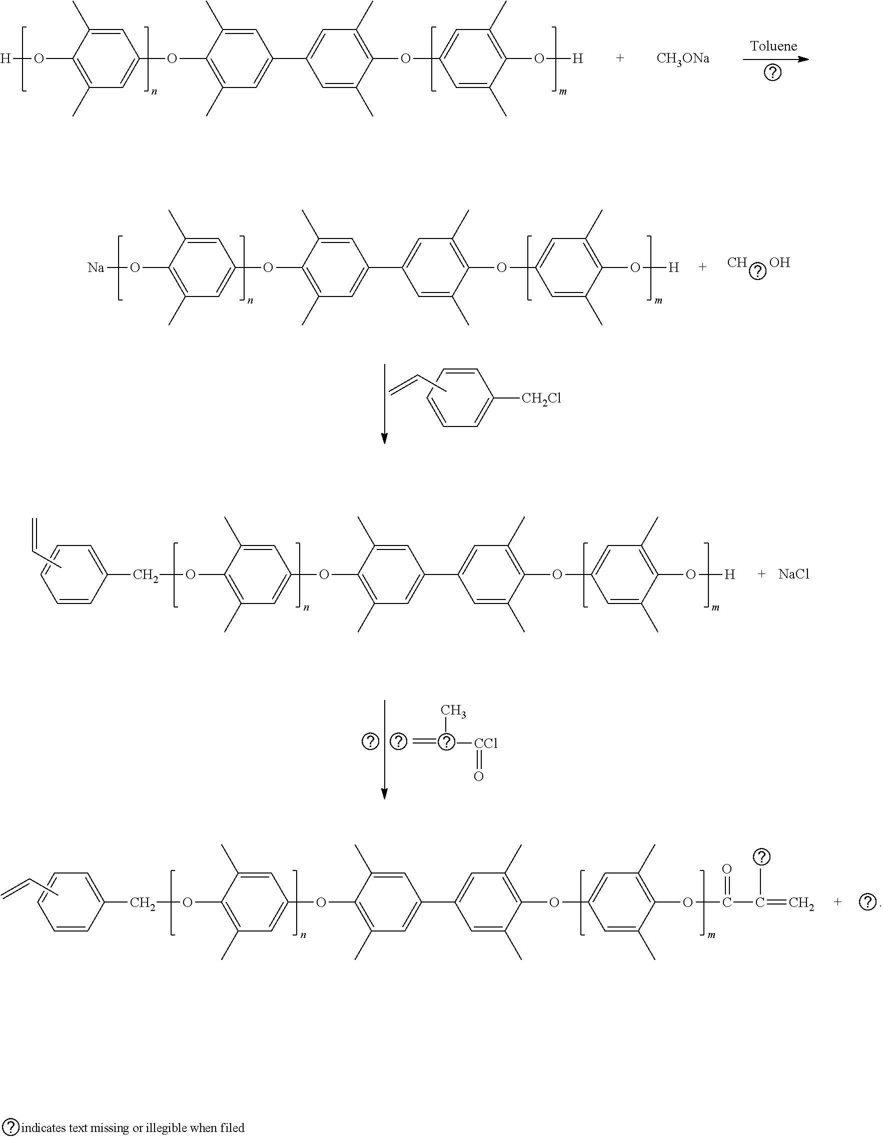

(3) 1 kg of the crude product of the low-molecular weight asymmetric thermosetting PPO resin polymer obtained by combining multiple batches prepared according to step (2) was added into 2,500 g of DMF, and 0.4 g of TBC was supplemented. They were dissolved at 35° C. 65 g of diethylamine was then added. The resulting mixture was stirred for 2 h, and then slowly poured into 18 kg of distilled water to make precipitation occur. After suction filtration, an obtained filter cake was added to 18 kg of distilled water and pulverized with a “wall breaker”, and stirred for 1 h. After suction filtration, an obtained filter cake was added to 18 kg of distilled water, and beating was conducted for 1 h. 30 g of CH₃COOH was added thereto to adjust a pH value to less than 6 (specifically 30 g of CH₃COOH). After suction filtration, an obtained filter cake was added to 18 kg of distilled water to conduct beating for 1 h. After suction filtration, an obtained filter cake was added to 4 kg of methanol, and beating was conducted twice, each time for 1 h, and 0.14 g of TBC was added during the beating of the last time in methanol. After suction filtration, an obtained product was dried to obtain 970 g of a low-molecular weight asymmetric thermosetting PPO resin polymer with a structural formula as shown in formula 1.

In this example, the low-molecular weight asymmetric thermosetting PPO resin polymer had a yield of 97% (by weight), a chlorine content of 45 ppm, a salt content of 30 ppm, and a Df of 0.0028.

### EXAMPLE 2

(1) PPO was prepared according to the method of step (1) in Example 1.

(2) To a reaction flask with a volume of 5 L, equipped with a stirrer, a thermometer, and a condenser, 800 g of the PPO, 800 g of toluene, and 800 g of DMF were added. The PPO was completely dissolved at 40° C. 56 g of sodium ethoxide was then added thereto in batches. The resulting mixture was stirred at 50° C. to 60° C. for 1 h. Ethanol therein was removed under reduced pressure (using a mechanical pump to 60° C.). The remaining was cooled, and 120 g of mixed vinylbenzyl chloride (including 76 wt % of o-vinylbenzyl chloride, 17 wt % of p-vinylbenzyl chloride, and 5 wt % of m-vinylbenzyl chloride) was added thereto dropwise at 40° C. After adding dropwise, an obtained reaction solution was held at 40° C. for 3 h and held at 60° C. for 3 h. After the heat preservation, the reaction solution was cooled to 30° C., 87 g of TEA was added, and 83 g of methacryloyl chloride was added dropwise at 30° C. After adding dropwise, a reaction solution was held at 30° C. for 3 h and held at 60° C. for 3 h. After the reaction, an obtained reaction solution was added dropwise to a mixed solution of 4,000 g of methanol, 200 g of hydrochloric acid, and 500 g of water (under stirring), solids were precipitated, and stirring was continued for 0.5 h. Suction filtration was conducted, an obtained filter cake was washed several times with 10 L of deionized water, and immersed in methanol for 0.5 h. The suction filtration was conducted, and a resulting product was dried at 80° C. to obtain 875 g of a crude product of a low-molecular weight asymmetric thermosetting PPO resin polymer. The dielectric characteristics of the crude product of the low-molecular weight asymmetric thermosetting PPO resin polymer are shown in Table 1.

A chemical reaction equation was as follows:

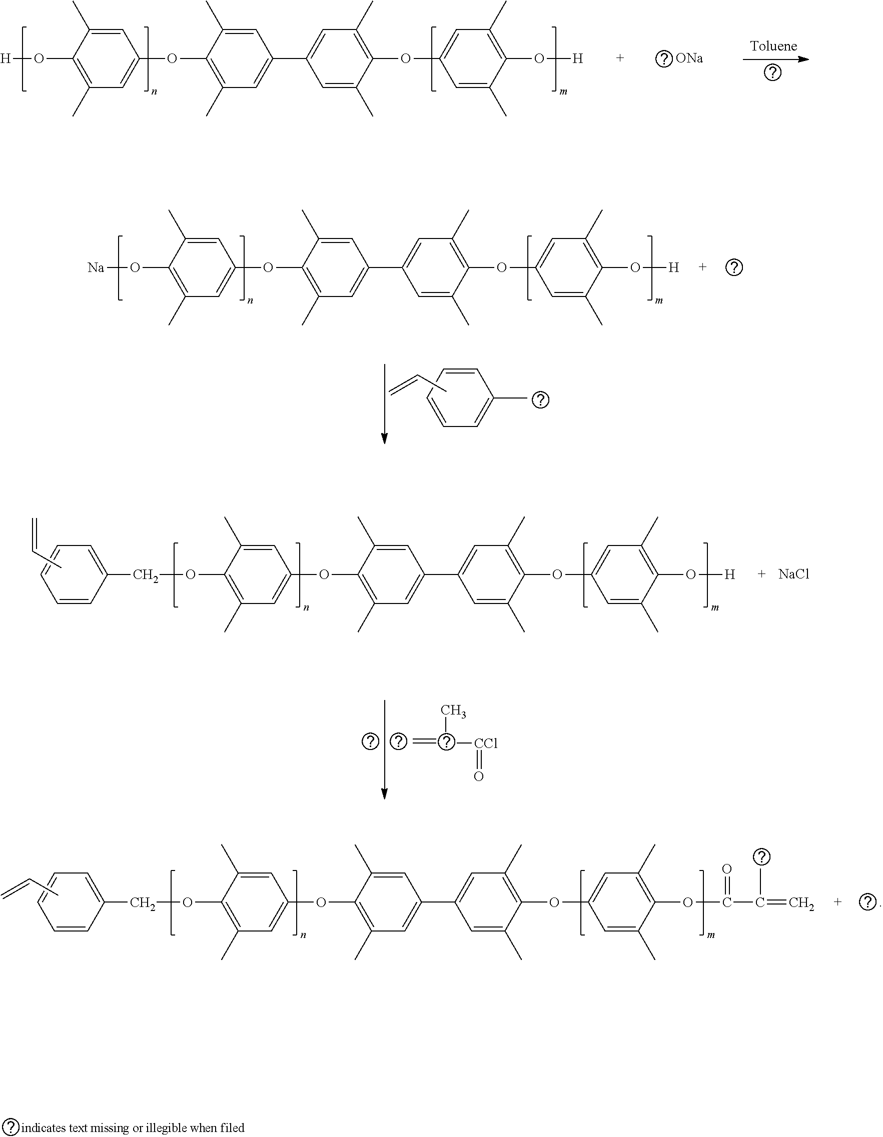

(3) 1 kg of the crude product of the low-molecular weight asymmetric thermosetting PPO resin polymer obtained by combining multiple batches prepared according to step (2) was added into 2,500 g of DMF, and 0.4 g of TBC was supplemented. After they were dissolved at 35° C., 65 g of diethylamine was added thereto. The resulting mixture was stirred for 2 h, and then slowly poured into 18 kg of distilled water to make precipitation occur. After suction filtration, an obtained filter cake was added to 18 kg of distilled water and pulverized with a “wall breaker”, and stirred for 1 h. After suction filtration, an obtained filter cake was added to 18 kg of distilled water, and beating was conducted for 1 h. 30 g of CH3COOH was added to adjust a pH value to less than 6 (specifically 30 g of CH₃COOH). After suction filtration, an obtained filter cake was added to 18 kg of distilled water, and beating was conducted for 1 h. After suction filtration, an obtained filter cake was added to 4 kg of methanol, and beating was conducted twice, each time for 1 h, and 0.14 g of TBC was added during the beating of last time in methanol. After suction filtration, an obtained product was dried to obtain 972 g of a low-molecular weight asymmetric thermosetting PPO resin polymer with a structural formula as shown in formula 1.

In this example, the low-molecular weight asymmetric thermosetting PPO resin polymer had a yield of 97.2% (by weight), a chlorine content of 43 ppm, a salt content of 27 ppm, and a Df of 0.0030.

### EXAMPLE 3

(1) PPO was prepared according to the method of step (1) in Example 1.

(2) To a reaction flask, with a volume of 5 L, equipped with a stirrer, a thermometer, and a condenser, 800 g of the PPO and 1,600 g of DMF were added. The PPO was completely dissolved at 80° C. and then cooled. 56 g of sodium ethoxide was added thereto in batches at 40° C. The resulting mixture was stirred at 50° C. to 60° C. for 1 h, and ethanol therein was removed under reduced pressure (using a mechanical pump to 60° C.). The resulting mixture was cooled, and 120 g of mixed vinylbenzyl chloride (including 76 wt % of o-vinylbenzyl chloride, 17 wt % of p-vinylbenzyl chloride, and 5 wt % of m-vinylbenzyl chloride) was added dropwise at 40° C. After adding dropwise, an obtained reaction solution was held at 40° C. for 3 h and held at 60° C. for 3 h. After the heat preservation, the reaction solution was cooled to 30° C., 87 g of TEA was then added thereto, and 83 g of methacryloyl chloride was added dropwise at 30° C. After adding dropwise, a reaction solution was held at 30° C. for 3 h and held at 60° C. for 3 h. After the reaction, an obtained reaction solution was added dropwise to a mixed solution of 4,000 g of methanol, 200 g of hydrochloric acid, and 500 g of water (under stirring), solids were precipitated, and stirring was continued for 0.5 h. Suction filtration was conducted, and an obtained filter cake was washed several times with 10 L of deionized water, and immersed in methanol for 0.5 h. The suction filtration was conducted, and a resulting product was dried at 80° C. to obtain 870 g of a crude product of a low-molecular weight asymmetric thermosetting PPO resin polymer. The dielectric characteristics of the crude product of the low-molecular weight asymmetric thermosetting PPO resin polymer are shown in Table 1.

Chemical reaction equation was as follows:

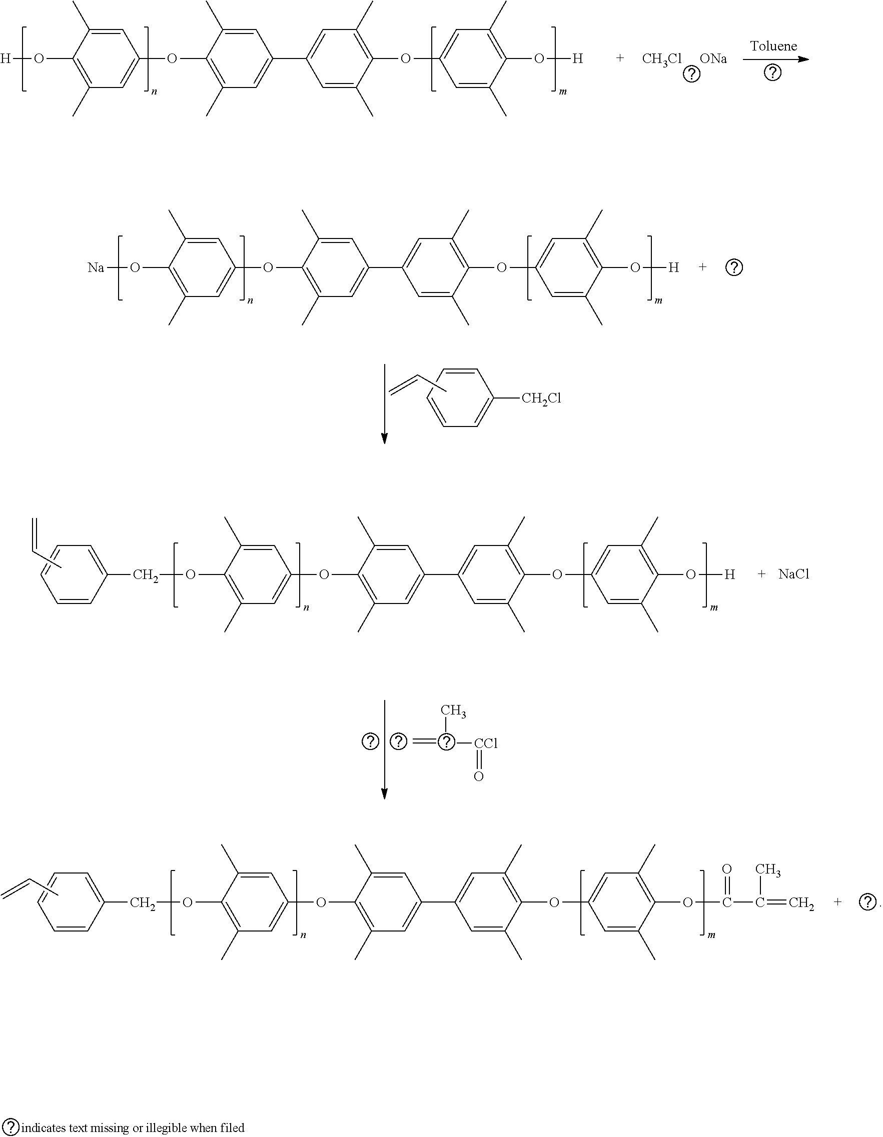

(3) 1 kg of the crude product of the low-molecular weight asymmetric thermosetting PPO resin polymer obtained by combining multiple batches prepared according to step (2) was added into 2,500 g of DMF, and 0.4 g of TBC was supplemented. The resulting mixture was stirred for 2 h, and then slowly poured into 18 kg of distilled water to make precipitation occur. After suction filtration, an obtained filter cake was added to 18 kg of distilled water and pulverized with a “wall breaker”, and stirred for 1 h. After suction filtration, an obtained filter cake was added to 18 kg of distilled water, and beating was conducted for 1 h, and 30 g of CH₃COOH was added to adjust a pH value to less than 6 (specifically 30 g of CH₃COOH). After suction filtration, an obtained filter cake was added to 18 kg of distilled water, and beating was conducted for 1 h. After suction filtration, an obtained filter cake was added to 4 kg of methanol, and beating was conducted twice, each time for 1 h, and 0.14 g of TBC was added thereto during the beating of last time in methanol. After suction filtration, an obtained product was dried to obtain 980 g of a low-molecular weight asymmetric thermosetting PPO resin polymer with a structural formula as shown in formula 1.

In this example, the low-molecular weight asymmetric thermosetting PPO resin polymer had a yield of 98% (by weight), a chlorine content of 39 ppm, a salt content of 25 ppm, and a Df of 0.0025.

### COMPARATIVE EXAMPLE 1

(1) PPO was prepared according to the method of step (1) in Example 1.

(2) To a reaction flask with a volume of 5 L, equipped with a stirrer, a thermometer, and a condenser, 800 g of the PPO, 1,600 g of toluene, and 5 g of DMF were added. The PPO was completely dissolved at 80° C. The resulting solution was cooled, 176 g of TEA was then added thereto at 30° C. 166 g of methacryloyl chloride was added dropwise at 30° C. After adding dropwise within 2 h, a reaction solution was held at 30° C. for 3 h and held at 60° C. for 3 h. After the reaction, an obtained reaction solution was slowly poured into a mixed solution of 4,000 g of methanol and 100 g of hydrochloric acid (under stirring), solids were precipitated, and stirring was continued for 0.5 h. Suction filtration was conducted, and an obtained filter cake was washed several times with 10 L of deionized water, and immersed in methanol for 0.5 h. The suction filtration was conducted, and a resulting product was dried at 80° C. to obtain 840 g of a PPO resin composition. The dielectric characteristics of the PPO resin composition are shown in Table 1.

Chemical reaction equation was as follows:

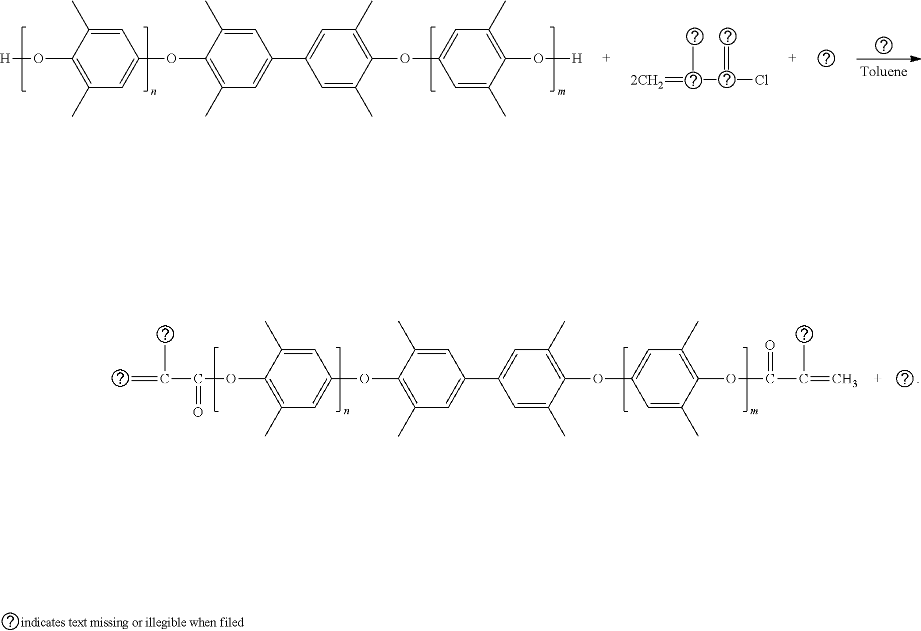

In this comparative example, the low-molecular weight thermosetting PPO resin polymer had a yield of 105% (by weight), a chlorine content of 44 ppm, a salt content of 44 ppm, and a Df of 0.0041.

### COMPARATIVE EXAMPLE 2

(1) PPO was prepared according to the method of step (1) in Example 1.

(2) To a reaction flask with a volume of 5 L, equipped with a stirrer, a thermometer, and a condenser, 800 g of the PPO and 1,600 g of toluene were added. The PPO was completely dissolved at 80° C. The resulting solution was then cooled, and 112 g of sodium ethoxide was added thereto in batches at 40° C. The resulting mixture was stirred at 50° C. to 60° C. for 1 h, and ethanol therein was removed under reduced pressure (using a mechanical pump to 60° C.). The resulting mixture was cooled, and 240 g of mixed vinylbenzyl chloride (including 76 wt % of o-vinylbenzyl chloride, 17 wt % of p-vinylbenzyl chloride, and 5 wt % of m-vinylbenzyl chloride) was added dropwise at 40° C. After adding dropwise, an obtained reaction solution was held at 40° C. for 3 h and held at 60° C. for 3 h. After the heat preservation, the reaction solution was cooled to 30° C., and then added dropwise to a mixed solution of 4,000 g of methanol, 200 g of hydrochloric acid, and 500 g of water (under stirring), solids were precipitated, and stirring was continued for 0.5 h. Suction filtration was conducted, and an obtained filter cake was washed several times with 10 L of deionized water, and immersed in methanol for 0.5 h. The suction filtration was conducted, and a resulting product was dried at 80° C. to obtain 880 g of a crude product of a low-molecular weight thermosetting PPO resin polymer. The dielectric characteristics of the crude product of the low-molecular weight thermosetting PPO resin polymer are shown in Table 1.

Chemical reaction equation was as follows:

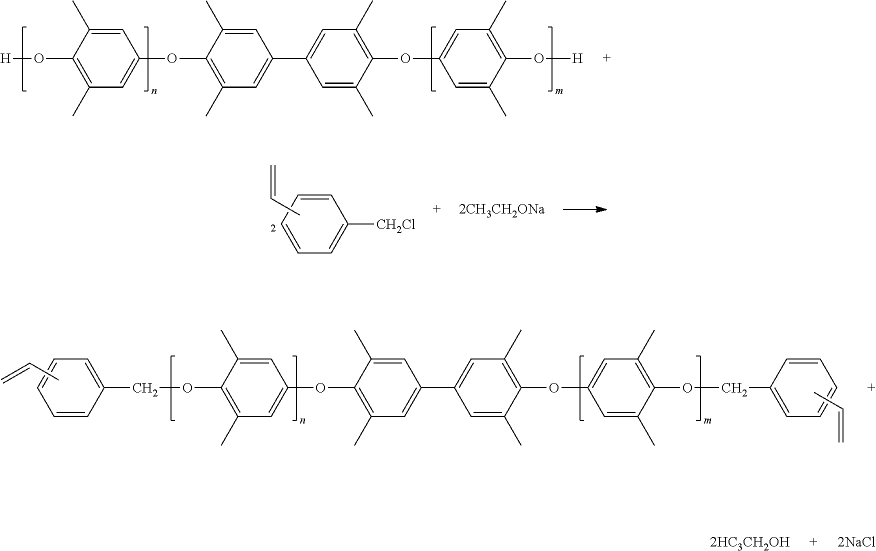

(3) 1 kg of the crude product of the low-molecular weight thermosetting PPO resin polymer obtained by combining multiple batches prepared according to step (2) was added into 2,500 g of DMF, and 0.4 g of TBC was supplemented. After they were dissolved at 35° C., 65 g of diethylamine was added thereto. The resulting mixture was stirred for 2 h, and then slowly poured into 18 kg of distilled water to make precipitation occur. After suction filtration, an obtained filter cake was added to 18 kg of distilled water and pulverized with a “wall breaker”, and stirred for 1 h. After suction filtration, an obtained filter cake was added to 18 kg of distilled water, and beating was conducted for 1 h, and 30 g of CH3COOH was added to adjust a pH value to less than 6. After suction filtration, an obtained filter cake was added to 18 kg of distilled water, and beating was conducted for 1 h. After suction filtration, an obtained filter cake was added to 4 kg of methanol, and beating was conducted twice, each time for 1 h, and 0.14 g of TBC was added during the beating of last time in methanol. After suction filtration, an obtained product was dried to obtain 990 g of a low-molecular weight thermosetting PPO resin polymer.

In this comparative example, the low-molecular weight thermosetting PPO resin polymer had a yield of 99%, a chlorine content of 47 ppm, a salt content of 37 ppm, and a Df of 0.0039.

### TEST EXAMPLE

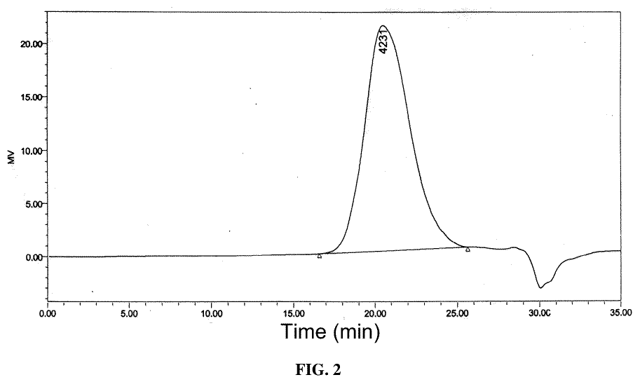

(1) The number-average molecular weight and the weight-average molecular weight were determined by GPC (as shown in FIG. 2). Data processing was conducted according to a GPC curve and a molecular weight calibration curve of the samples. A molecular weight calibration curve was obtained by obtaining an approximate value of a relationship between a molecular weight of standard polystyrene and its dissolution time according to the equation:

$$Log M = {A}_{0} {X}^{3} + {A}_{1} {X}^{2} + {A}_{2} X + {A}_{3} + {A}_{4} / {X}^{2} ;$$

where

M represents the molecular weight; X represents an elution time, i.e., 19 min; and A₀ to A₄ each represent coefficients.

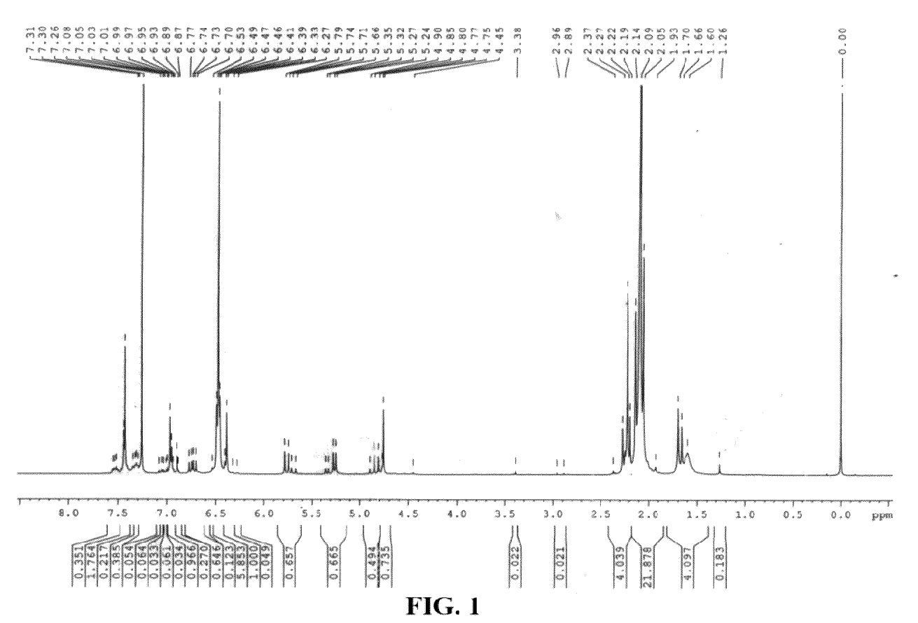

(2) FIG. 1 shows an ¹H-NMR spectrum of the low-molecular weight asymmetric thermosetting PPO resin polymer prepared in Example 1. The peaks of vinyl benzyl ether and methacryloyl ether in ¹H-NMR spectrum confirm that a low-molecular weight asymmetric thermosetting PPO resin polymer has been prepared in the present disclosure.

(3) In the pH determination, an electrode Inpro4250SG/225/Pt1000 produced by METTLER TLED was used.

(4) The dielectric constants and dielectric loss tangents of cured products were obtained by cavity resonance perturbation.

TABLE 1
Dielectric properties of crude products of low-molecular weight asymmetric
thermosetting PPO resin polymers prepared in Examples
1 to 3 and Comparative Examples 1 to 2.

| Conditions and | | | | Comparative | Comparative |
|---|---|---|---|---|---|
| performances | Example 1 | Example 2 | Example 3 | Example 1 | Example 2 |
| Reaction solvent | Toluene and | Toluene and | DMF | Toluene and | Toluene |
| | DMF | DMF | | DMF | |
| Alkoxide | Sodium | Sodium | Sodium | / | Sodium |
| | methoxide | ethoxide | ethoxide | | ethoxide |
| Acid-binding agent | TEA | TEA | TEA | TEA | / |
| Acidic substance | Hydrochloric | Hydrochloric | Hydrochloric | Hydrochloric | / |
| | acid | acid | acid | acid | |
| Mn (g/mol) | 1848 | 1864 | 2004 | 1960 | 2057 |
| Mw (g/mol) | 3546 | 3518 | 4180 | 4154 | 4226 |
| Dielectric constant | 2.55 | 2.6 | 2.51 | 2.67 | 2.61 |
| (10 GHz) | | | | | |
| Dielectric loss | 0.0035 | 0.0038 | 0.0032 | 0.0041 | 0.0039 |
| tangent (10 GHz) | | | | | |

As shown in Table 1, the low-molecular weight asymmetric thermosetting resin polymers prepared in Example 1, Example 2, and Example 3 and the low-molecular weight thermosetting resin polymers prepared in Comparative Example 1 and Comparative Example 2 have little difference in number average molecular weight (Mn) and weight average molecular weight (Mw), and all show desirable solubility in toluene and methyl ethyl ketone. However, Examples 1 to 3 adopt two kinds of end-capping groups of vinyl benzyl chloride and methacryl at both ends, respectively. The dielectric constant and dielectric loss tangent of the asymmetric low-molecular weight PPO resin are better than those of Comparative Examples 1 to 2. Although the excellent amplitude is not particularly obvious, the test data after subsequent film formation is incomparable relative to that of Comparative Examples 1 to 2. This proves that the polymer of the present disclosure has leading properties and a particularly excellent comprehensive performance.

The above description of embodiments is merely provided to help understand the method of the present disclosure and a core idea thereof. It should be noted that, several improvements and modifications may be made by a person of ordinary skill in the art without departing from the principle of the present disclosure, and these improvements and modifications should also fall within the scope of the present disclosure. Various amendments to these embodiments are apparent to those of professional skill in the art, and the general principles defined herein may be implemented in other embodiments without departing from the spirit or scope of the present disclosure. Thus, the present disclosure is not limited to the embodiments shown herein but falls within the widest scope consistent with the principles and novel features disclosed herein.

1. A low-molecular weight asymmetric thermosetting polyphenylene oxide resin polymer, having a structural formula as shown in formula 1: 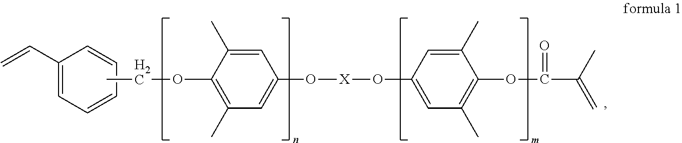
wherein in formula 1, —O—X—O— is 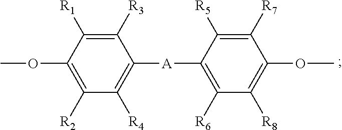
R¹, R², R⁷, and R⁸ are each independently selected from the group consisting of a halogen atom, an alkyl having 1 to 6 carbon atoms, and an aryl;
R³, R⁴, R⁵, and R⁶ are each independently selected from the group consisting of hydrogen atom, a halogen atom, an alkyl having 1 to 6 carbon atoms, and an aryl;
A is a single bond or selected from the group consisting of a linear hydrocarbylene group having 1 to 6 carbon atoms, a branched hydrocarbylene group, and a cyclic hydrocarbylene group; and
n and m are each independently an integer of 1 to 30.

2. The low-molecular weight asymmetric thermosetting polyphenylene oxide resin polymer as claimed in claim 1, wherein the n is in a range of 1 to 20; and the m is in a range of 1 to 20.

3. The low-molecular weight asymmetric thermosetting polyphenylene oxide resin polymer as claimed in claim 1, wherein X is selected from the group consisting of

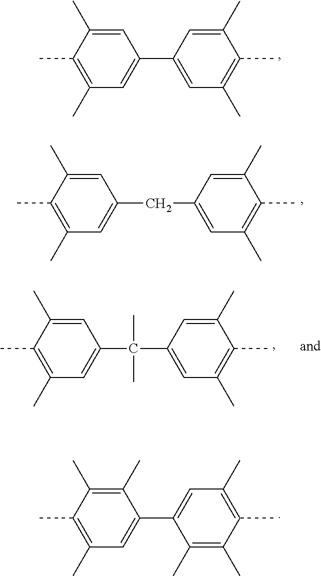

4. A method for preparing a low-molecular weight asymmetric thermosetting polyphenylene oxide resin polymer, the low-molecular weight asymmetric thermosetting polyphenylene oxide resin polymer having a structural formula as shown in formula 1: 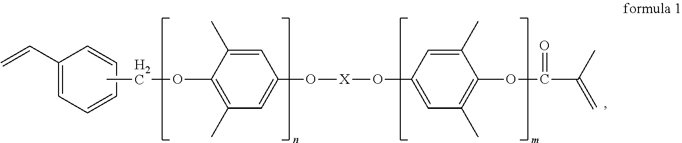
wherein in formula 1, —O—X—O— is 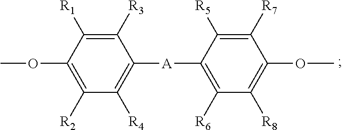
R¹, R², R⁷, and R⁸ are each independently selected from the group consisting of a halogen atom, an alkyl having 1 to 6 carbon atoms, and an aryl;
R³, R⁴, R⁵, and R⁶ are each independently selected from the group consisting of hydrogen atom, a halogen atom, an alkyl having 1 to 6 carbon atoms, and an aryl;
A is a single bond or selected from the group consisting of a linear hydrocarbylene group having 1 to 6 carbon atoms, a branched hydrocarbylene group, and a cyclic hydrocarbylene group; and
n and m are each independently an integer of 1 to 30;
the method comprising the steps of
mixing a bifunctional polyphenylene oxide oligomer, a polar aprotic solvent, an alkali metal alkoxide, and a vinylbenzyl halide, and subjecting a resulting mixture to an etherification reaction, to obtain an etherification reaction system;
mixing the etherification reaction system with an acid-binding agent and a methacryloyl halide, and subjecting a resulting mixture to an esterification reaction to obtain an esterification reaction system; and
adjusting a pH value of the esterification reaction system to 6.0-8.0, and adding the esterification reaction system after adjusting to water or a water-alcohol mixed solution to make precipitation occur, to obtain the low-molecular weight asymmetric thermosetting polyphenylene oxide resin polymer;
wherein the bifunctional polyphenylene oxide oligomer has a structural formula as shown in formula 2:

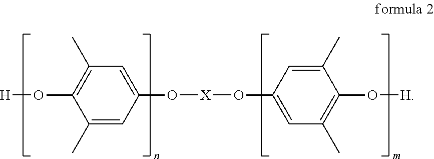

5. The method as claimed in claim 4, wherein the polar aprotic solvent comprises one or more selected from the group consisting of toluene, N,N-dimethylformamide, N,N-dimethylacetamide, and 1-methyl-2-pyrrolidone.

6. The method as claimed in claim 4, wherein the alkali metal alkoxide comprises one or more selected from the group consisting of lithium methoxide, sodium methoxide, potassium methoxide, lithium ethoxide, sodium ethoxide, and potassium ethoxide.

7. The method as claimed in claim 4, wherein the vinylbenzyl halide comprises one or more selected from the group consisting of m-vinylbenzyl chloride, p-vinylbenzyl chloride, m-vinylbenzyl bromide, and p-vinylbenzyl bromide.

8. The method as claimed in claim 4, wherein a molar ratio of the alkali metal alkoxide to a phenolic hydroxyl group in the bifunctional polyphenylene oxide oligomer is in a range of (0.9-4.8):1; and a molar ratio of the vinylbenzyl halide to the phenolic hydroxyl group in the bifunctional polyphenylene oxide oligomer is in a range of (0.5-2.0):1.

9. The method as claimed in claim 4, wherein the etherification reaction is conducted at a temperature of 0-90° C. for 10 min to 30 h.

10. The method as claimed in claim 4, wherein the acid-binding agent comprises one or more selected from the group consisting of triethylamine, pyridine, N,N-diisopropylethylamine, 4-dimethylaminopyridine, triethanolamine, tetrabutylammonium bromide, potassium carbonate, ammonium carbonate, and sodium carbonate.

11. The method as claimed in claim 4, wherein the methacryloyl halide is one or two selected from the group consisting of methacryloyl chloride and methacryloyl bromide.

12. The method as claimed in claim 4, wherein a molar ratio of the acid-binding agent to the bifunctional polyphenylene oxide oligomer is in a range of (1-2):1; and
a molar ratio of the methacryloyl halide to a phenolic hydroxyl group in the bifunctional polyphenylene oxide oligomer is in a range of (0.5-2):1.

13. The method as claimed in claim 4, wherein the esterification reaction is conducted at a temperature of 0-90° C. for 10 min to 30 h.

14. A method for improving a purity of a low-molecular weight asymmetric thermosetting polyphenylene oxide resin polymer, comprising the steps of
mixing a crude product of a low-molecular weight asymmetric thermosetting polyphenylene oxide resin polymer prepared by the method as claimed in claim 4 with a polar aprotic solvent, a polymerization inhibitor, and diethylamine to obtain a mixed solution; adding the mixed solution into water to make precipitation occur, to obtain a first solid substance;
mixing the first solid substance with water, and pulverizing to obtain a first dispersion;
conducting solid-liquid separation on the first dispersion to obtain a second solid substance;
mixing the second solid substance with water, and conducting beating to obtain a second dispersion;
mixing the second dispersion with acetic acid, subjecting a resulting mixture to a neutralization reaction, and conducting solid-liquid separation to obtain a third solid substance; and
conducting beating on the third solid substance in water and methanol in sequence to obtain the low-molecular weight asymmetric thermosetting polyphenylene oxide resin polymer.

15. The method as claimed in claim 14, wherein the polymerization inhibitor is tris(2,3-dibromopropyl)isocyanurate.

16. The method as claimed in claim 14, wherein the low-molecular weight asymmetric thermosetting polyphenylene oxide resin polymer has a chlorine content of less than 50 ppm, a vinylbenzyl chloride content of less than or equal to 15 ppm, a NaCl content of less than or equal to 25 ppm, and a (C₂H₅)₃N·HCl content of less than or equal to 5 ppm.

17. (canceled)

18. The method as claimed in claim 8, wherein the etherification reaction is conducted at a temperature of 0-90° C. for 10 min to 30 h.

19. The method as claimed in claim 12, wherein the esterification reaction is conducted at a temperature of 0-90° C. for 10 min to 30 h.

20. The method as claimed in claim 4, wherein one of the following (a) and (b) is applied:
(a) the n is in a range of 1 to 20; and the m is in a range of 1 to 20; and
(b) X is selected from the group consisting of [chemical structure]
